(19) United States
(12) Patent Application Publication
(10) Pub. No.: US 2009/0164550 A1
(43) Pub. Date: Jun. 25, 2009

(54) MEDIA MONITORING

(75) Inventors: Timothy J. Rahrer, Ottawa (CA); Saurabh Srivastava, Ottawa (CA)

Correspondence Address: WITHROW & TERRANOVA, P.L.L.C., 100 REGENCY FOREST DRIVE, SUITE 160, CARY, NC, 27518, US

(73) Assignee: NORTEL NETWORKS LIMITED, St. Laurent (CA)

(21) Appl. No.: 11/961,879

(22) Filed: Dec. 20, 2007

(51) Int. Cl. G06F 15/16; G06F 11/07

(52) U.S. Cl. 709/202; 714/2; 714/25; 714/E11.02

(57) ABSTRACT

The present invention relates to providing monitoring agents in various elements of a switched digital media network. The monitoring agents may be placed in one or more of the following types of devices: customer premise equipment, access nodes, switching offices, hub offices, head end equipment, and the like. The monitoring agents may be located in any number of the types of devices at the same or different hierarchical levels in the switched digital media network. In different embodiments, the monitoring agents may be employed at different locations and provide various functionality, which may include capturing segments of streaming media, communicating with each other, providing and processing fault alarms, determining the location of fault alarms, or the like.

### FIELD OF THE INVENTION

The present invention relates to communications, and in particular to monitoring media to help identify or process faults.

### BACKGROUND OF THE INVENTION

With the evolution of the Internet and packet communications in general, audio and video services, such as voice communications, radio and television services, are being deployed over packet-based communication networks using the Internet protocol (IP). The delivery of television and related services over such networks is referred to as IP television (IPTV). One of the difficulties in transitioning from traditional television services to IPTV services has been the difficulty in maintaining consistent quality of service when delivering streaming media. As demands on the network vary, service quality may be adversely affected, especially during periods of high demand. In addition, there are a plethora of other potential causes of service quality degradation ranging from head-end encoding issues to client player faults. As such, service and network operators need the ability to monitor the performance of the complete system and make sure the application and network layers meet the demands of customers. For example, monitoring may occur at the network, or transport, layer level, as well as at the application layer. For example, lack of a signal may be due to a network element failure or cable cut (network layer) or due to an encoder failure (application layer).

In addition to the need to monitor the performance of the network and application layers, service providers also need to detect faults in a fast and efficient manner as well as take the necessary steps to address these faults. Unfortunately, the delivery of IPTV services involves a significant number of service nodes, and being able to determine where a fault is occurring in the overall network is often challenging. Further, when a fault occurs, hundreds or thousands of customers may be impacted. In certain instances, customer premise equipment (CPE) of the customers is capable of detecting a fault and sending a fault alarm to a network management system. However, when numerous faults are generated at the same time, the reporting of the faults not only takes up network resources, but often overwhelms the network management system. Accordingly, there is a further need for a way to manage the delivery and management of fault information within the network. There is a further need to quickly and efficiently identify the location of these faults.

### SUMMARY OF THE INVENTION

The present invention relates to providing monitoring agents in various elements of a switched digital media network. The monitoring agents may be placed in one or more of the following types of devices: customer premise equipment, access nodes, switching offices, hub offices, head end equipment, and the like. The monitoring agents may be located in any number of the types of devices at the same or different hierarchical levels in the switched digital media network. In different embodiments, the monitoring agents may be employed at different locations and provide various functionality, which may include capturing segments of streaming media, communicating with each other, providing and processing fault alarms, determining the location of fault alarms, or the like.

In one embodiment, a first monitoring agent may be capable of capturing a segment of a media stream in response to receiving an impairment trigger, which was provided in response to an impairment event being detected at the first monitoring agent or other monitoring agents. The first monitoring agent may be able to buffer the media stream prior to receiving the impairment trigger, and thus be able to capture a media segment that starts before and ends after the impairment trigger is received. The media segment may be stored in a secure location and analyzed locally or uploaded to another monitoring agent or management system for analysis. Metadata associated with the media segment as well as other related information, such as performance logs, may be stored in association with the media segment. Notably, synchronization information may be provided in the metadata to enable corresponding media segments from different monitoring agents to be analyzed together.

As indicated, the various monitoring agents may be able to communicate with each other, even if the monitoring agents are located on the same or different hierarchical levels in the switched digital media network. The monitoring agents may be grouped into peer groups where each monitoring agent may have a peer list that identifies the peers of the monitoring agent. Such communications may allow the monitoring agents to inform each other of fault conditions and exchange status information. The monitoring agents may also instruct each other to take certain actions, which may include recording and storing portions of a general or specific media stream. In one embodiment, one monitoring agent may instruct another monitoring agent to change to another media stream and begin monitoring or recording that media stream, which is referred to as forced tuning. Such force tuning may allow a monitoring agent that is experiencing a fault on a particular media stream to see if another monitoring agent is experiencing the same fault on that particular media stream.

Further, certain monitoring agents may act to aggregate fault alarms that are being reported by other monitoring agents at the same or lower hierarchical levels in the switched digital media network and provide fault information corresponding to the fault alarms to higher level monitoring agents or management systems. As such, fault alarms that are propagating upstream through the switched digital media network may be effectively consolidated or filtered to reduce to reduce the possibility of the switched digital media network being flooded by fault alarms when widespread faults occur. The monitoring agents may also be able to suppress fault alarms of the monitoring agents at the same or lower hierarchical levels in the switched digital media network after receiving fault alarms from other monitoring agents that are experiencing the same or a different fault.

In other embodiments, the monitoring agents may be able to cooperate with one another to isolate a possible fault location. For example, monitoring agents at the same or different hierarchical levels may communicate with each other to determine whether a certain fault is present. Based on the information gathered by the monitoring agents and an understanding of the topology of the switched digital media network, the likely location of the fault may be detected. Notably, monitoring agents on the same or different hierarchical levels may be able to locate faults at locations throughout the switched digital media network with certain network configurations.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of a switched digital media network according to one embodiment of the present invention.

FIG. 2 is a block representation of a customer premises according to one embodiment of the present invention.

FIG. 3 is a block representation of a switched digital media network according to a second embodiment of the present invention.

FIG. 4 is a block representation of a switched digital media network according to a third embodiment of the present invention.

FIG. 5 is a block representation of a switched digital media network according to a fourth embodiment of the present invention.

FIGS. 6A and 6B provide a flow diagram for a fault isolation process according to one embodiment of the present invention.

FIG. 7 is a block representation of a switched digital media network according to a fifth embodiment of the present invention.

FIG. 8 is a block representation of a switched digital media network according to a sixth embodiment of the present invention.

FIG. 9 is a block representation of a switched digital media network according to a seventh embodiment of the present invention.

FIGS. 10A and 10B provide a flow diagram for a fault isolation process according to a second embodiment of the present invention.

FIG. 11 is a block representation of a switched digital media network according to an eighth embodiment of the present invention.

FIGS. 12A, 12B, and 12C provide a flow diagram for a fault isolation process according a third embodiment of the present invention.

FIG. 13 is a block representation of a service node according to one embodiment of the present invention.

FIG. 14 is a block representation of customer premise equipment according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

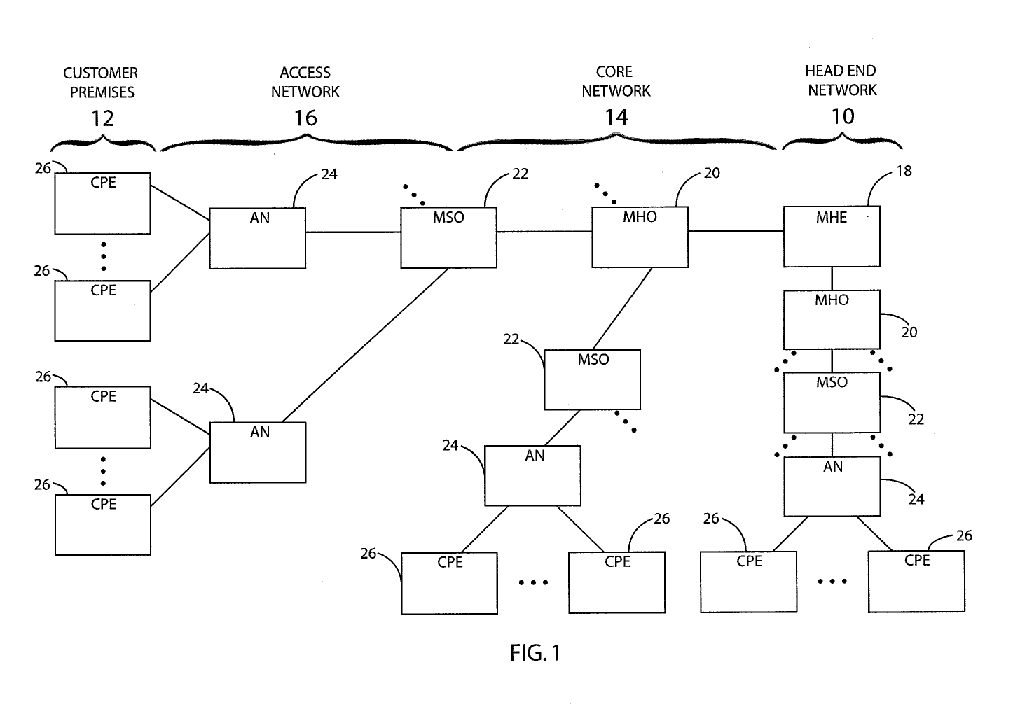

Switched digital media networks allow the delivery of streaming media in the form of media streams for various channels, which can be selected by customers for listening or viewing. Switched digital media networks may represent satellite, cable, internet protocol television (IPTV), or like networks used to deliver audio or video for a public or private setting. Typically, service providers rely on an extensive and hierarchical based network, which branches out from a centralized location where media content is aggregated and extends to the customer premises through various intermediate networks. An exemplary switched digital media network is illustrated in FIG. 1. The centralized location where media is aggregated resides in a head end network 10, which is configured to deliver the various media streams for the corresponding channels to customer premises 12 through intermediate core networks 14 and access networks 16. The access networks 16 provide wired or wireless access to the customer premises 12 and the core networks 14 represent the primary transport networks that connect the various access networks 16 to the head end network 10.

In particular, a media head end (MHE) 18, such as a super head end for video, resides in the head end network 10. The MHE 18 will generally have access to various satellite dish farms, media servers, or the like, which provide the various media content for the corresponding channels to the MHE 18. The MHE 18 aggregates the media content from the various sources and allocates the media content for delivery toward the customer premises 12 at the appropriate time and on the appropriate channel. Notably, the media content may be delivered to the customer premises 12 according to a predefined schedule or in response to a customer request, as is provided for video on demand services. Notably, the media content may include advertising content, which is slotted into appropriate slots within the media content. In video or television based switched digital media networks, the advertising content provided by the head end network 10 is generally national advertising intended for delivery to customers over a wide geographic area.

Media content delivered toward one or more customer premises 12 may pass through a media hub office (MHO) 20, which resides in the core network 14. Although not required, a single MHO 20 may be allocated to a single city or metro area. The MHO 20 may have access to local media content, including local advertising, which may be provided in association with the media content being provided by the MHE 18. In addition to providing local advertising, local emergency alert messages or content may be injected into the media content at the MHOs 20. Both the MHE 18 and the MHOs 20 may provide various types of encoding and decoding as well as transcoding to effectively change encoding, compression, and formatting associated with the media content being delivered toward the customer premises 12. The next service node in the path towards the customer premises 12 may include a media switching office (MSO) 22, which generally resides in the city or metro area being served by the MSO 22. Further, the MSOs 22 may be distributed throughout the corresponding geographic location, such as in association with one or more neighborhoods. Within each of these neighborhoods or corresponding areas, each MSO 22 may be associated with a number of access nodes (AN) 24, which may also be referred to as access multiplexers. These access nodes 24 effectively aggregate all of the wired or wireless connections between the various customer premises 12. The MSO 22 and the access node 24 are generally associated with the corresponding access network 16. As illustrated, a single access node 24 may serve customer premise equipment (CPE) 26 at any number of customer premises 12. As depicted, each CPE 26 may represent one or more devices or networks at a particular customer premises 12. The exemplary access networks 16 include digital subscriber lines (DSL), passive optical networks (PON), Ethernet networks, cellular networks, WiMAX networks, and the like. The access nodes 24 may include DSL access modems (DSLAMs), optical modems, Ethernet modems, cellular base stations, wireless access points, and the like.

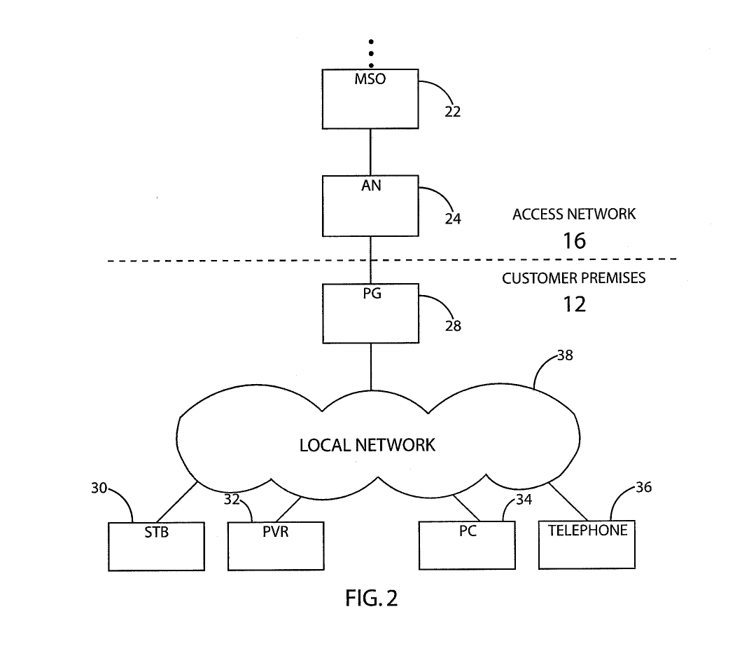

As illustrated, media content aggregated by the MHE 18 may be delivered toward the various CPEs 26 through their corresponding MHOs 20, MSOs 22, and access nodes 24. Once inside the customer premises 12, and in particular the CPE 26 for that customer premises 12, the media content may be delivered to any number of devices, as illustrated in FIG. 2. Notably, the customer premises 12 may, but need not, include a premises gateway (PG) 28, such as a residential gateway, that provides a gateway function between the access network 16 and any CPE 26, such as a set top box (STB) 30, personal video recorder (PVR) 32, personal computer (PC) 34, telephone 36, local network 38, or the like. The telephone 36 may be a fixed or mobile terminal, such as a cellular telephone or personal digital assistant. Notably, FIG. 2 is merely used to illustrate that the CPE 26 may take various forms and a particular customer premises 12 may include multiple endpoints, gateways, and networks connecting there between. These examples are illustrative and are not intended to limit the type or scope of devices that represent the CPE 26.

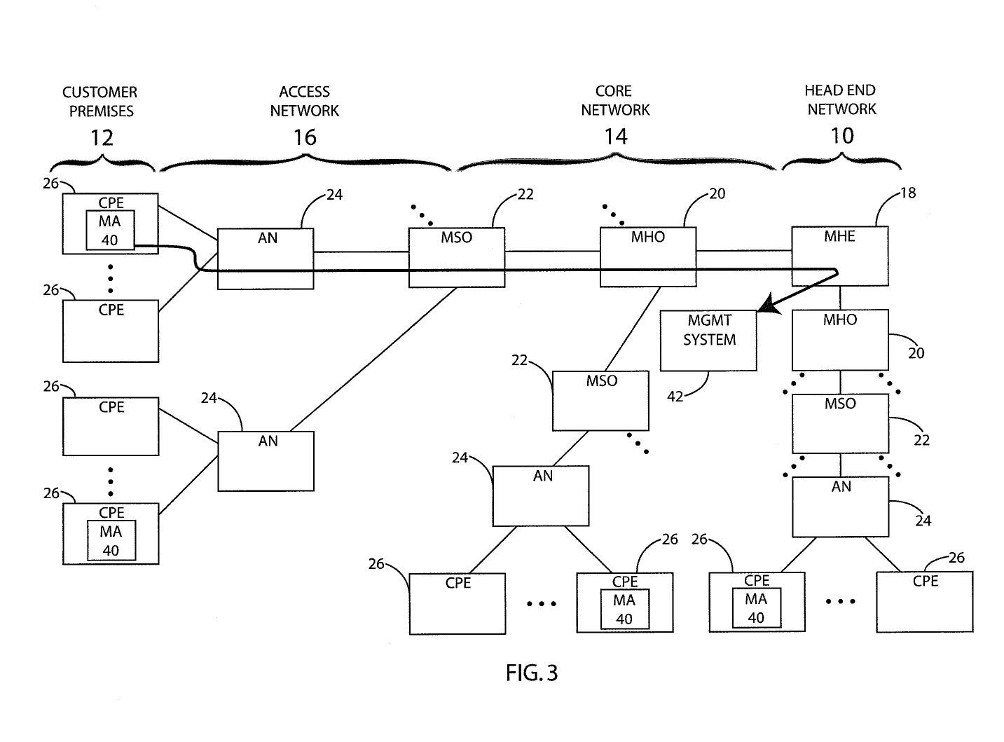

With reference to FIG. 3, one embodiment of the present invention may employ a monitoring agent (MA) 40, which is located within the CPE 26 at various customer premises 12. The monitoring agents 40 may be configured to record media streams in response to an impairment trigger. The impairment trigger may be provided by the CPE 26 in which the monitoring agent 40 resides, by another monitoring agent 40 in the same or a different customer premises 12, or by a person. The person may include the customer, service personnel, or the like. As will be described further below, the impairment trigger may come from a monitoring agent 40 that resides outside of the customer premises 12. Regardless of the source, the impairment trigger is indicative of a fault, which can be virtually any impairment, problem, or the like that is being detected somewhere by someone or some device.

In response to receiving an impairment trigger, the monitoring agent 40 may initiate a process of capturing a portion of the streaming media for one or more channels to a diagnostic storage location on a local storage medium. If the device on which the monitoring agent 40 resides was already recording the streaming media, for example a personal video recorder (PVR), the portion of the streaming media that is stored in the diagnostics location may include a portion of the streaming media that was received prior to receiving the impairment trigger, as will be discussed in further detail below. Accordingly, the monitoring agent 40 is configured to record and store a portion of the streaming media in association with receiving the impairment trigger. The impairment trigger may identify the particular streaming media to record if the monitoring agent is not aware of the particular streaming media that is associated with the impairment trigger.

The purpose of storing a portion of the streaming media in association with an impairment trigger is to make a portion of the streaming media available for subsequent analysis in an effort to diagnose the cause of the impairment that is associated with the impairment trigger. Impairments may relate to application layer playback errors, which may include, but are not limited to, motion pictures expert group (MPEG) transport layer faults, program clock reference problems, quality of service issues, as well as the recognition of missing frames, lost packets, and the like. Network layer impairments may include excessive loss, delay, or jitter at IP or MPEG packet levels. Even if the faults are not detected, the end user or service personnel may manually initiate the trigger through an appropriate user interface, such as a graphical user interface, input panel, or remote control. As noted above, a monitoring agent 40 which is experiencing difficulty may request another monitoring agent 40 to capture and store streaming media for a particular channel in an effort to determine if the streaming media at different locations are experiencing the same issues.

Regardless of how the impairment trigger is provided, the monitoring agent 40 will store an associated portion of the streaming media to a local storage medium associated with the monitoring agent 40. This stored media segment may be uploaded through a file transfer process or streamed to an appropriate management system 42 for analysis. Notably, the monitoring agent 40 may provide its own analysis of the stored media segment based on local information, such as network performance measurements, application errors, and the like, or from information received from other monitoring agents 40, as well as the management system 42. The stored media segment may be stored in a protected area on the device that supports the monitoring agent 40, or another device on the customer premises 12. For example, if a monitoring agent 40 is provided in a PVR 32, a PC 34, or an STB 30, which has a memory structure, the media segment may be stored thereon. Alternatively, a readily accessible memory structure, such as that provided by a network attached storage (NAS) device or the like may be used to store the media segment. The location at which the media segment is stored is not critical, but it is preferred to have the area in which the media segment is stored in the memory architecture to be protected and accessible only for authorized use.

When recording streaming media in response to receiving an impairment trigger, it is preferable to capture a portion of the streaming media that occurs some time before, during, and after receiving the impairment trigger, and preferably before, during, and after the actual event that may have caused the impairment. As such, it is preferable to provide some type of buffer using solid state memory or a hard drive to record streaming media for one or more channels in a continuous fashion, such that the streaming media is buffered for a certain amount of time. Different applications may allow for differing buffer periods. For example, solid state embodiments may only allow buffering for less than a few seconds, and disk based systems may allow buffering for several minutes, up to several hours. Regardless of the type of memory architecture, the use of buffering allows the monitoring agent 40 to capture a media segment from the streaming media, wherein the media segment represents a portion of the streaming media before, during, and after the monitoring agent 40 detects an impairment trigger. As such, the likelihood of being able to capture the manifestation of an impairment, if available, is significantly enhanced even for impulsive, short duration impairments. The stored media segment may be captured and stored at various protocol levels and in various formats, depending on the desires of the service provider. For example, the stored media segment may correspond to raw IP packets, media stream formats, such as encoded file formats, decoded file formats, and the like. Further, the stored media segment may be stored in an encrypted or decrypted version.

In one embodiment, metadata that corresponds to the stored media segment is also captured and associated with the stored media segment. The metadata may be stored as an associated text or like file as well as more traditional metadata, which is actually stored or integrated with the media content of the stored media segment. The metadata may include any type of information that is available and deemed helpful in analyzing impairments that are associated with the stored media segment. Exemplary metadata may include the following: date, time, monitoring agent 40 location, a media stream identifier, such as a program ID, channel number, asset reference, or the like. The metadata may also include the source of the impairment trigger, the type of impairment trigger, and the relative severity of the impairment trigger. The metadata may also include the length of the stored media segment and a flag to indicate whether the stored media segment has been analyzed, transferred to another device for monitoring, and the like. If other information is available that is not stored as metadata, a link to this information may be provided in the metadata. For example, if the CPE 26 on which the monitoring agent 40 resides maintains a service quality monitoring log, the metadata may provide a link to this log. The monitoring agent 40 may also keep a service quality monitoring log itself, which is used to trigger the recording. The log could measure any one of the performance parameters as defined by standards bodes such as DSL Forum (TR-135 Data Model for a TR-069-enabled STB), ATIS (ATIS-0800004 IPTV QoS Framework Document, ATIS-0800008 QoS Metrics for Linear Broadcast IPTV), or ITU. Proprietary quality parameters may be calculated, monitored, and logged as well. If the log is synchronized with the stored media segment, the link may provide a pointer to the portion of the log that corresponds to the stored media segment. Thus, the stored media segment may include or otherwise be associated with metadata, which was not part of the portion of the streaming media that was recorded, but may provide insight on analyzing the stored media segment in light of the impairment trigger or impairment event.

The recording of the stored media segments may be configured as desired. For example, service providers may dictate how much of the streaming media is stored before receiving the impairment trigger as well as the overall duration of the stored media segment. The relative start and duration times for a stored media segment may be prioritized based on the severity of the impairment event, or fault, which caused the impairment trigger. Earlier start times and greater durations may be associated with more severe impairment events. Further, different types of impairment events may require different relative start and duration times. The duration of the stored media segments may also be based on the amount of memory available to store these media segments. The stored media segments may be maintained as long as memory is available, and when memory becomes scarce, those stored media segments that are older or associated with less severe impairment events may be deleted or overwritten first. Those skilled in the art will recognize the tremendous flexibility in determining the relative length and scope of the stored media segments relative to the impairment triggers.

The monitoring agents 40 are preferably configured to communicate with each other and perhaps the management system 42. Further, the monitoring agents 40 may be placed in or in association with the CPEs 26, as well as the access nodes 24, the MSOs 22 or within network or application elements therein, the MHOs 20 or within network or application elements therein, and the MHE 18 or within network or application elements therein. Notably, monitoring agents 40 could be standalone elements within the MSO, MHO, or MHE, or could be part of a network element in the MSO, MHO, or MHE such as an aggregation switch or router, or may be part of an application layer element such as an encoder, video distribution router, or the like. With reference to FIG. 3, an embodiment is illustrated wherein only certain CPEs 26 include monitoring agents 40. It is further illustrated that the monitoring agent 40 is capable of communicating with the management system 42. In this embodiment, communications are provided through the access node 24, the MSO 22, the MHO 20, and the MHE 18; however, those skilled in the art will recognize that the management system 42 may be distributed or located in any of the various access networks 16, core networks 14, and head end networks 10. Such communications may include exchanging control information as well as providing alarms in association with impairment triggers to the management system 42 and providing stored media segments that were captured in association with an impairment trigger to the management system 42.

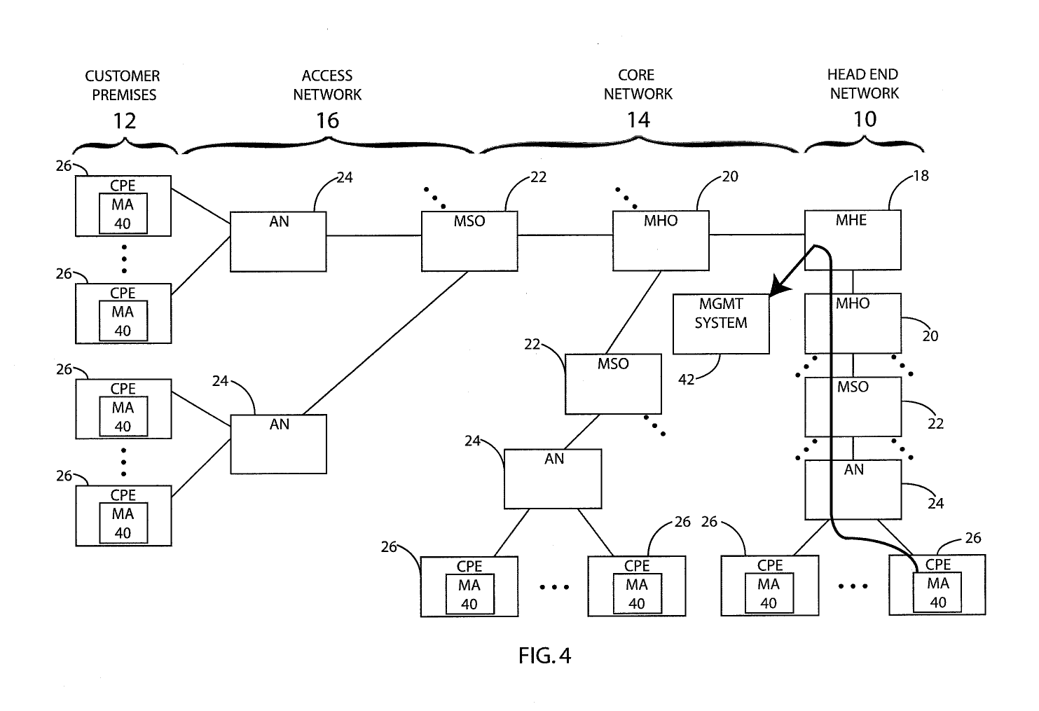

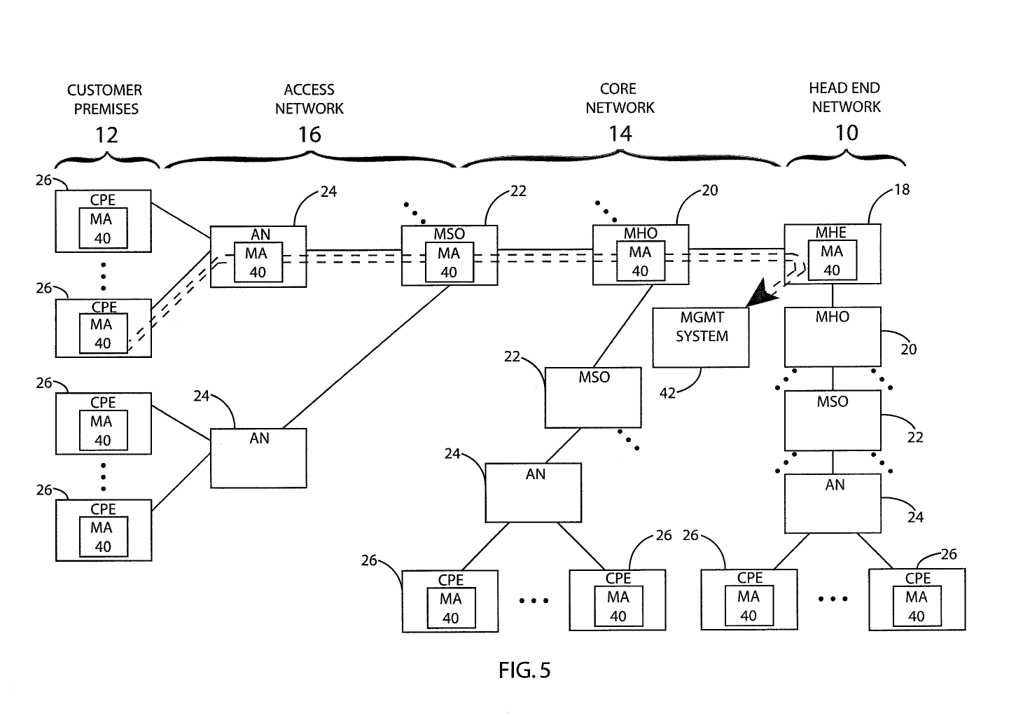

With reference to FIG. 4, an embodiment is illustrated wherein monitoring agents 40 are provided in substantially all of the CPEs 26. Again, the monitoring agents 40 are capable of communicating with the management system 42. With reference to FIG. 5, an embodiment is illustrated wherein the monitoring agents 40 may also be associated with or incorporated in the access node 24, the MSO 22, the MHO 20, and the MHE 18. Thus, monitoring agents 40 in a CPE 26 may reconfigure to communicate with monitoring agents 40 in any one or all of the access node 24, the MSO 22, the MHO 20, and the MHE 18. Further, the monitoring agents 40 and any one of the access node 24, the MSO 22, the MHO 20, and the MHE 18 may communicate with each other. As illustrated, any of the monitoring agents 40 may also communicate with the management system 42. The benefits of allowing these monitoring agents 40 to act as peers, regardless of their location, provides tremendous flexibility in determining which devices are experiencing a problem, controlling the reporting of alarms associated with these problems, as well as determining the location of the problem.

To facilitate communications between monitoring agents 40 that reside on the CPEs 26, access nodes 24, MSOs 22, MHOs 20, or MHEs 18, the monitoring agents 40 may maintain a peer list. The peer list identifies the list of peer monitoring agents 40 with which any given monitoring agent 40 may communicate, and preferably provides any necessary addressing to facilitate such communications. A basic peer list may be provided by the management system 42, which keeps track of the various monitoring agents 40, and which of those monitoring agents 40 are peers of each other. These peer lists may be downloaded to the various monitoring agents 40 and may be updated on a periodic basis. As an example, the peers of a CPE 26 may include: nearby CPEs 26 that are supported by the same access node 24; CPEs 26 that are supported by the same MSO 22, but supported by a different access node 24; CPEs 26 that are served by the same MHO 20, but a different MSO 22; CPEs 26 that are served by the same MHE 18, but a different MHO 20, and the like. Different scenarios may allow different monitoring agents 40 to have different peers. In other words, not all monitoring agents 40 need to be peers of one another. Further, the monitoring agents 40 may maintain address lists, which identify nearby or related monitoring agents 40, based on the network topology. As such, monitoring agents 40 that are not on a given peer list may still be accessible by another monitoring agent 40 through an intermediate monitoring agent 40.

A more sophisticated technique for generating and maintaining peer lists would allow the monitoring agents 40 to dynamically discover other monitoring agents 40 and update their peer lists accordingly. Monitoring agents 40 may dynamically detect new monitoring agents 40 being added to the network and update their peer lists accordingly. Alternatively, newly added monitoring agents 40 may dynamically detect other peers in the network. The peer lists, even when they are dynamically updated, may remain relatively static unless there is a change in the presence or availability of a monitoring agent 40. Alternatively, the peer lists may be maintained based on a particular issue being addressed. As such, the monitoring agents 40 may be able to communicate with each other to determine those monitoring agents 40 that are involved with a particular issue, and the peer lists may identify those monitoring agents 40 working on that issue.

Regardless of how the peer lists are created and maintained, they may include additional information, such as the streaming media being received or monitored by the various monitoring agents 40, active or past alarms that have been provided by the various monitoring agents 40, and the like. In essence, the peer lists may include various static and real-time status information for the peers in the peer lists. Notably, the peer lists may identify a master peer for all or a particular group of peer monitoring agents 40.

The communications between monitoring agents 40 may include data and control information. Exemplary data information may include peer configuration information, peer status information, alarm or trigger status information, as well as peer list information. The peer configuration information may include the identity, capabilities, such as the availability of a recording function, physical location, identity of a master peer, or the like for a given monitoring agent 40. The peer status information may identify a current monitoring mode or the identification of media streams, such as television channels, that are being monitored. The monitoring mode may indicate whether the monitoring is more of a trending nature over a longer term or a comprehensive, real-time monitoring as well as the type of monitoring being provided. The alarm or trigger status information may include the metadata, which was described above, or the like. Again, those skilled in the art will recognize that various types of information may be communicated between the monitoring agents 40 according to the present invention.

In general, the control information may be used to initiate actions on a peer monitoring agent 40. In other words, one monitoring agent 40 may send control information to another monitoring agent 40, which will initiate an action based on that control information. In one embodiment, the control information is used for controlling certain diagnostic functions. For example, a controlling monitoring agent 40 may instruct a controlled monitoring agent 40 to enable information logging or add tags to previously logged files. As such, the controlled monitoring agent 40 may begin keeping track of performance information on a systematic or real-time basis. Further, the controlled monitoring agent 40 may add tags to existing log files to indicate that the controlling monitoring agent 40 has had certain problems at certain times. The controlling monitoring agent 40 may also instruct other monitoring agents 40 to upload stored media segments, performance logs, and the like to a master monitoring agent 40, an upstream monitoring agent 40, or the management system 42.

Some of the more beneficial diagnostic functions to control relate to having the controlling monitoring agent 40 instruct a controlled monitoring agent 40 to capture one or more active media streams, capture a particular segment of the media stream, or tune to a particular media stream and begin capturing that media stream. The latter function is referred to as forced tuning.

For forced tuning, the controlled monitoring agent 40 may transition to the requested streaming media or request the particular streaming media. The forced tuning may occur even if a customer associated with the controlled monitoring agent 40 is not listening to or viewing the streaming media to which the monitoring agent 40 is forced tuned. Regardless of whether the controlling monitoring agent 40 requests the recording of an active media stream or the forced tuning of a particular media stream, the controlled monitoring agent 40 may be provided with information bearing on the start time and duration for media segments to be captured from the streaming media along with other impairment or logging related information.

To avoid disturbing another customer's service experience, the controlling monitoring agent 40 and the controlled monitoring agent 40 may communicate with each other to negotiate a convenient time when forced tuning of the controlled monitoring agent 40 is appropriate. Convenient times may include times when the CPE 26 is off or has resources available to tune to the requested channel without affecting the customer's listening or viewing experience, such as when bandwidth is available to tune and record an additional media stream. In other scenarios, the forced tuning may take place in the background, unbeknownst to the customer, or at a time when the customer is not receiving streaming media. The controlling monitoring agent 40 may also communicate to multiple controlled monitoring agents 40 simultaneously in order to ensure one or more has resources free to tune to the desired media stream. In yet other scenarios, knowledge of the channels to which each controlled monitoring agent 40 is currently tuned, or which controlled monitoring agents 40 have resources free to tune to an additional channel, may be communicated to the controlling monitoring agent 40 for use in selection of which monitoring agent 40 to use for requests for recording of media streams and performance logging. Further, the controlling monitoring agent 40 and the controlled monitoring agent 40 may exchange synchronization flags or provide information to allow the synchronization of corresponding media segments, which were captured from the streaming media. As such, the media segments recovered from different monitoring agents 40 may be readily synchronized and compared to facilitate fault analysis.

Given the extensive monitoring and communication capabilities of the monitoring agents 40, certain faults may result in a large number of monitoring agents 40, at various levels in the network, recognizing a fault. In many instances, faults are reported to other monitoring agents 40, the management system 42, or both. As such, when a large number of monitoring agents 40 report faults, the network resources may be taxed. In general, the closer the fault gets to the MHE 18, the number of monitoring agents 40 that are impacted significantly increases, given the hierarchical nature of the network.

In one embodiment, the various monitoring agents 40 are divided into peer groups. Each peer group may have one monitoring agent 40 identified as a master peer. The monitoring agents 40 within a peer group may reside in the same or different types of devices. For example, a peer group may include an access node 24 and all of the CPEs 26 that are supported by that access node 24. The master peer in such a peer group may be the monitoring agent 40 in the access node 24 or one of the CPEs 26. Other peer groups may only include CPEs 26, which are supported by the same or different access nodes 24, MSOs 22, MHOs 20, and MHEs 18. In general, the peers in the peer group will send fault alarms to the master peer of the group automatically, or in response to a request for fault information from the master peer. The master peer may correlate available fault alarms and send information bearing on the various fault alarms to the management system 42 or another master peer. In certain embodiments, the master peers may be grouped, and from this higher level group, a higher level master peer is selected. In addition to receiving fault alarms from the peers in a peer group, the master peer may also send instructions to disable fault reporting to the peers in the peer group.

The master peer may be predefined or dynamically determined in general or for a particular fault. For example, the first peer in a peer group that experiences a fault may become the master peer for the peer group with respect to that fault. Alternatively, the peers in the peer group may provide an election process to select a master peer based on any number of criteria.

The master peers for any peer group may provide various processing of the fault alarms. In a basic embodiment, the fault alarms may be summarized and passed upstream to another monitoring agent 40 or the management system 42 by the master peer. In other embodiments, the master peer may analyze the various fault alarms and provide corresponding diagnostic data to higher level monitoring agents 40 or the management system 42. The monitoring agents 40 at the same or different levels in the network architecture may provide such aggregation or filtering to not only minimize the number of fault alarms that are propagated upstream toward the management system 42, but also provide the management system 42 with an analysis of the faults that caused the fault alarms.

In yet another embodiment, monitoring agents 40 that are in line between the CPE 26 and the MHE 18 may selectively aggregate fault alarms from downstream peers and limit the number of fault alarms sent out to the management system 42. The upstream peers may set priorities based on the number of fault alarms that are received from downstream peers. For example, rather than 100 STBs 30, which are connected to an access node 24, sending individual fault alarms upstream, the access node 24 may aggregate each of these fault alarms and send a single fault alarm indicating that there is a major, common problem occurring among each of the STBs 30. Similarly, the MSOs 22 may filter fault alarms received from the downstream access nodes 24 and so on and so forth for the MHO 20. Again, upstream peers may instruct downstream peers to suppress delivery of fault alarms in general or for particular faults as well as reset alarm conditions once other peers have reported the fault and the fault has been recognized by the upstream peer. Accordingly, upstream and downstream monitoring agents 40 may cooperate with one another to effectively control the reporting of faults to minimize the impact on network resources when large numbers of monitoring agents 40 detect the same fault.

The ability of the monitoring agents 40 to communicate with each other allows the monitoring agents 40 to cooperate with one another to isolate faults, which may impair streaming media. In essence, peers at the same or different levels may communicate with each other to determine whether a common fault is detected by the various monitoring agents 40. Based on which monitoring agents 40 detect the fault and which monitoring agents 40 do not detect the fault, the location of the fault may be isolated to a particular entity or link between adjacent entities. Several examples follow to illustrate techniques for isolating the location of the fault. Notably, these scenarios are merely exemplary, and are not intended to represent all the possible isolation techniques that are available using the concepts of the present invention. The first scenario provides a bottom up approach, the second scenario provides a top down approach, and the third scenario provides a hybrid approach for isolating the location of the fault in the network using monitoring agents 40.

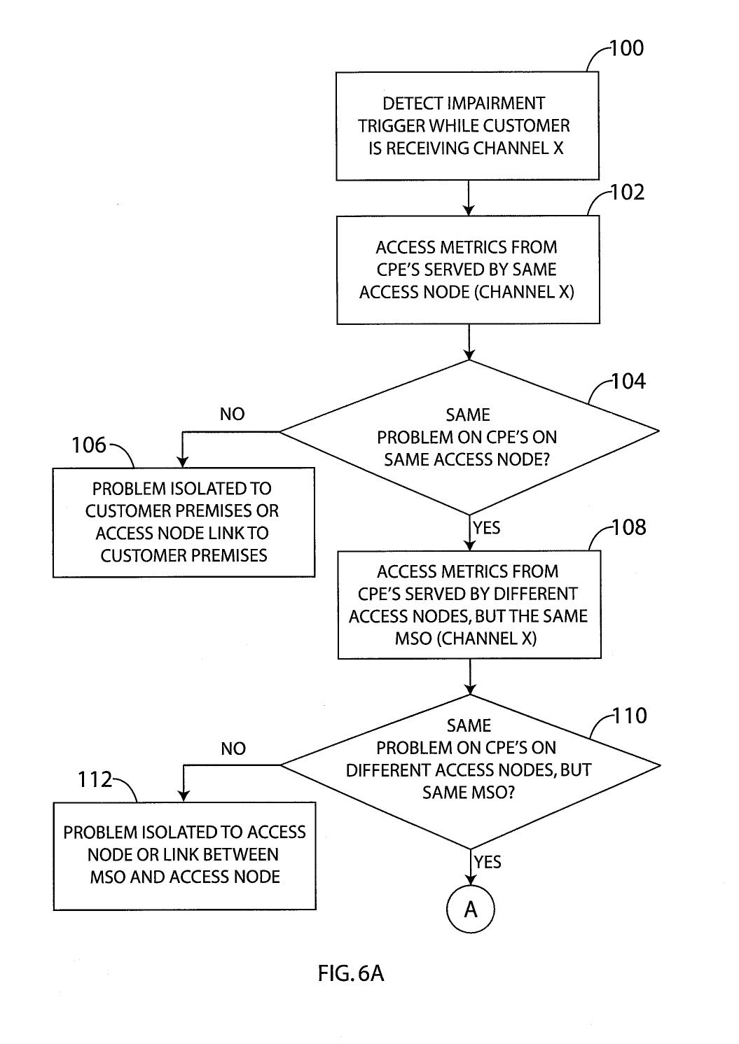

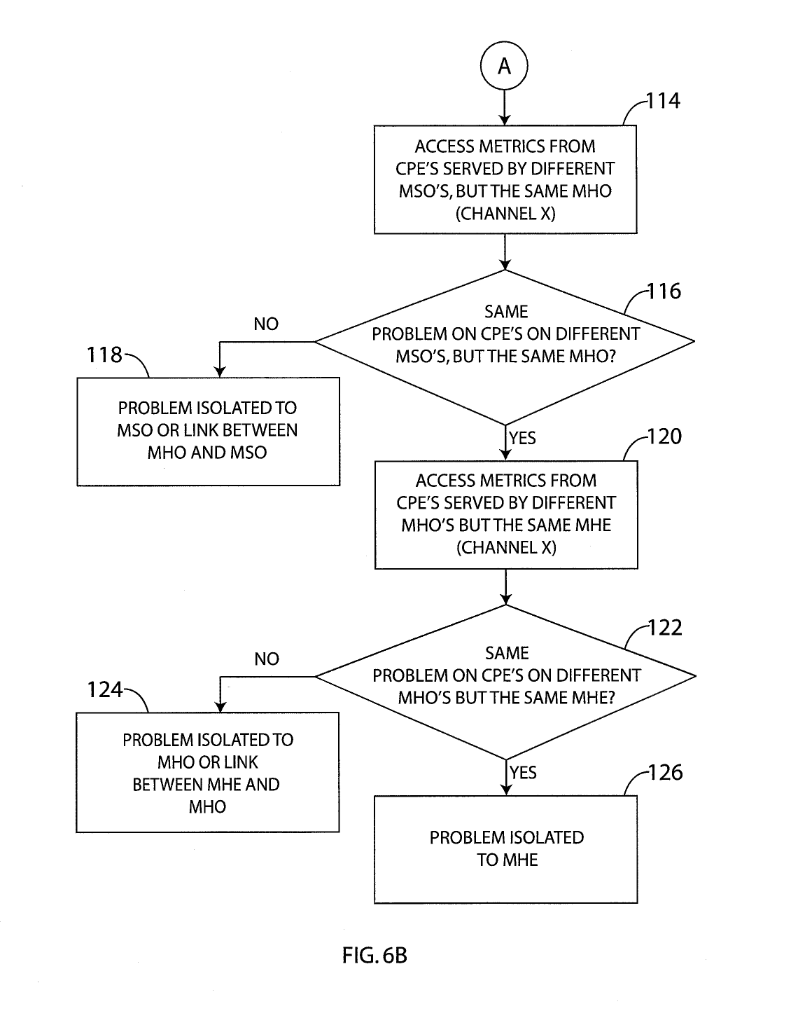

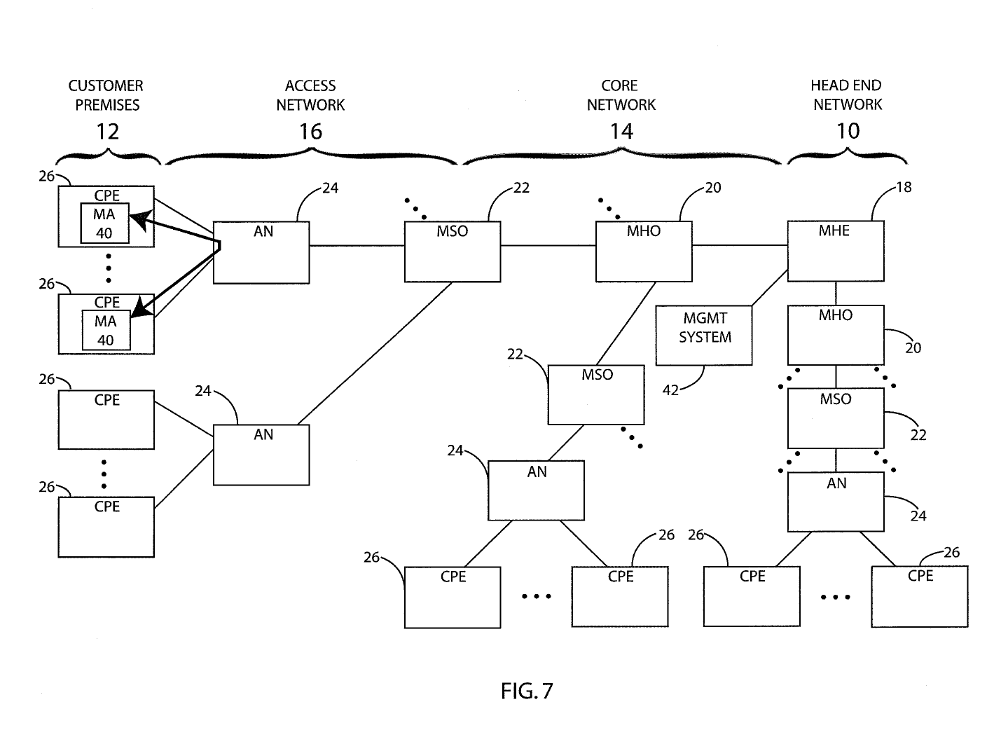

For the first scenario, assume that all or most of the CPEs 26 include monitoring agents 40, such as illustrated in FIG. 4. A flow diagram for the isolation process is provided in FIGS. 6A and 6B. Initially, the monitoring agent 40 in one of the CPEs 26 will detect an impairment trigger while a customer is receiving streaming media associated with channel X or the monitoring agent 40 is tuned to channel X (step 100). The monitoring agent 40 may then access metrics from CPEs 26 that are served by the same access node 24 (step 102). Accessing the metrics involves communicating with the monitoring agents 40 of the CPEs 26 that are served by the same access node 24. The metrics may relate to the ability of the CPEs 26 to receive channel X or to receive streaming media in general. This communication is represented in FIG. 7 where two CPEs 26, which are supported by a single access node 24, are illustrated as communicating with each other to request and receive these metrics.

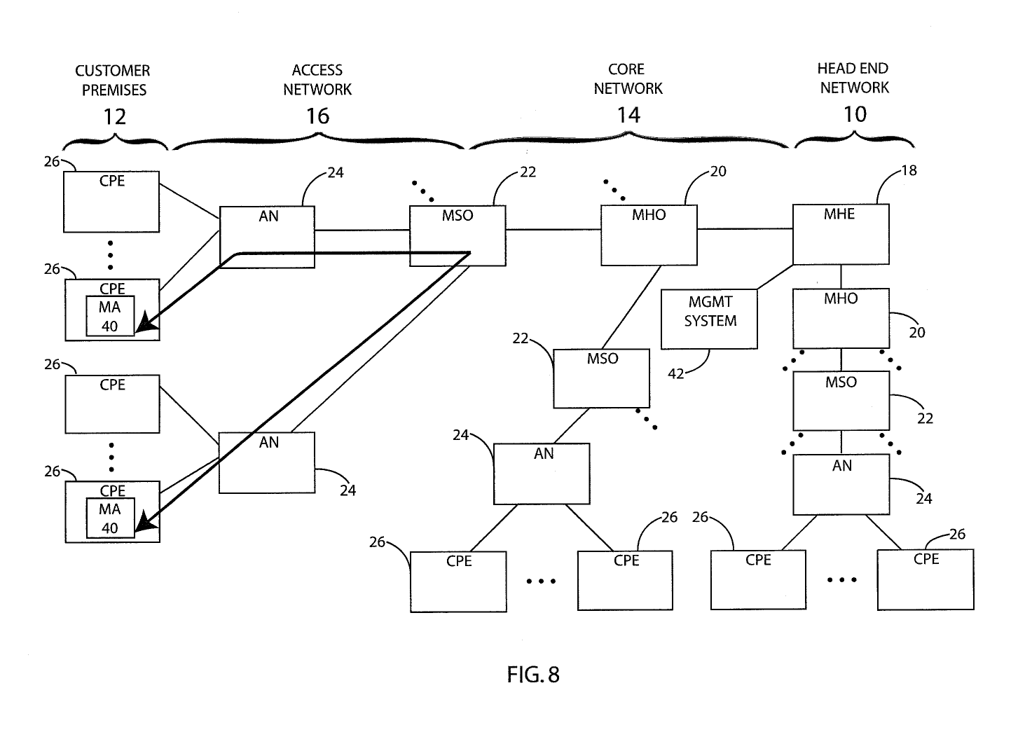

Upon accessing the metrics from the CPEs 26, the monitoring agent 40 will determine whether the same problem is being experienced by the CPEs 26 that are served by the same access node 24 (step 104). If the same problem is not detected by the other CPEs 26 that are served by the same access node 24, the monitoring agent 40 may determine that the problem is isolated to the customer premises 12, including the CPE 26 in which the monitoring agent 40 resides, or the access node link to the customer premises 12 from the access node 24 (step 106). If the same problem is experienced on other CPEs 26 that are served by the same access node 24, the monitoring agent 40 may access metrics from the CPEs 26 that are served by different access nodes 24, but the same MSO 22 (step 108). The communication between the CPEs 26 that are served by different access nodes 24, but the same MSO 22, is illustrated in FIG. 8. The monitoring agent 40 will then determine whether the same problem is experienced on the CPEs 26 that are served by different access nodes 24 but the same MSO 22 (step 110). If the same problem is not detected at the other CPEs 26, the monitoring agent 40 may determine that the problem is isolated to the access node 24 which serves the monitoring agent 40, or the link between the MSO 22 and the access node 24 (step 112).

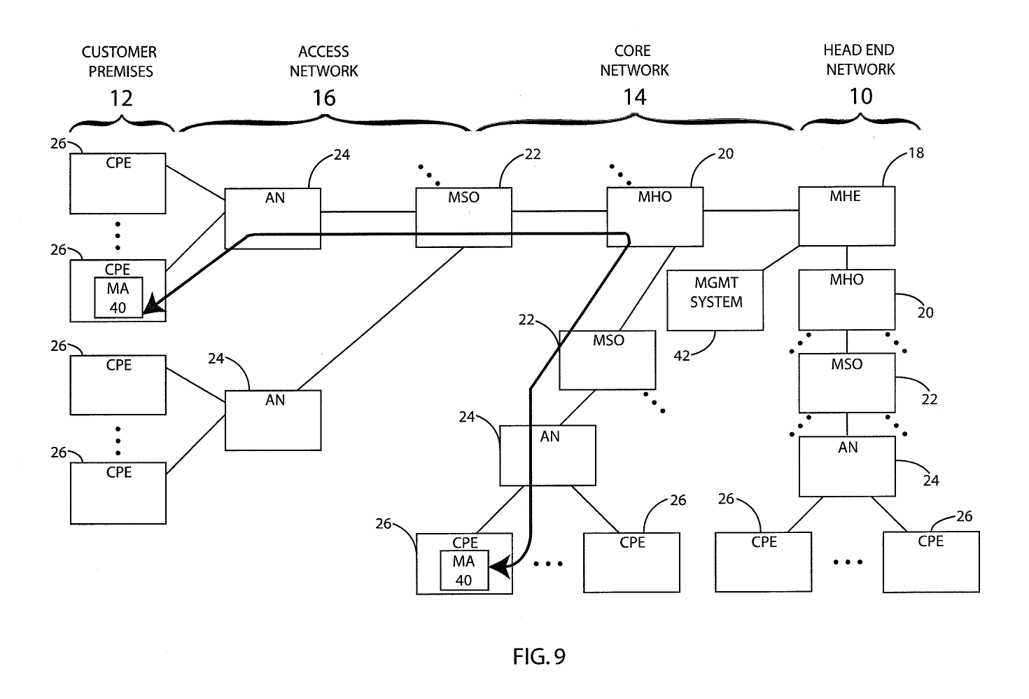

If the same problem is detected in the other CPEs 26, the monitoring agent 40 may access metrics from CPEs 26 that are served by different MSOs 22 but the same MHO 20 as illustrated in FIG. 9 (step 114). Again, the monitoring agent 40 will determine whether the same problem is detected on the CPEs 26 that are served by different MSOs 22 but the same MHO 20 (step 116). If the CPEs 26 do not detect the same problem, the monitoring agent 40 may determine that the problem is isolated to the MSO 22 or the link between the MHO 20 and the MSO 22 (step 118).

If the monitoring agent 40 determines that the same problem is detected on the CPEs 26 that are served by different MSOs 22 but the same MHO 20, the monitoring agent 40 may access metrics from CPEs 26 that are served by different MHOs 20, but the same MHE 18 as illustrated in FIG. 9 (step 120). The monitoring agent 40 may then determine whether the CPEs 26 that are served by different MHOs 20 but the same MHE 18 detect the same problem (step 122). If the monitoring agent 40 determines that the CPEs 26 are not detecting the same problem, the monitoring agent 40 may determine that the problem is isolated to the MHO 20 or the link between the MHE 18 and the MHO 20 (step 124). If the CPEs 26 served by different MHOs 20 but the same MHE 18 are experiencing the same problem, the monitoring agent 40 may determine that the problem is isolated to the MHE 18 (step 126). Once the problem is isolated, the management system 42 may be notified. Notably, this notification may come in the form of a fault alarm or some other form of diagnostic report. In certain embodiments, the monitoring agent 40 may immediately send a fault alarm upstream towards the management system 42 upon detecting the fault or receiving an impairment trigger. In either case, the monitoring agent 40 may initiate various communications between its peers to obtain information as well as provide control information, as described above. Accordingly, the monitoring agent 40 may instruct the other monitoring agents 40 to either force tune or begin recapturing corresponding media segments for channel X or other channels as well as initiate the exchange of prior or current faults. The exchange of impairment triggers may represent the reporting of faults among peers.

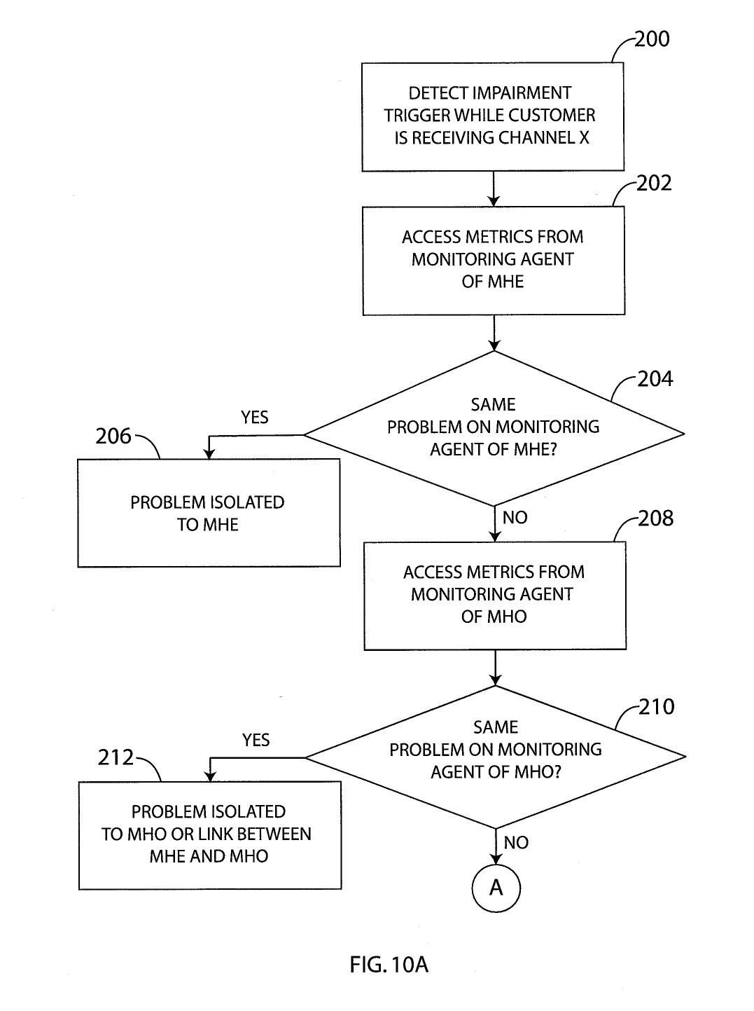

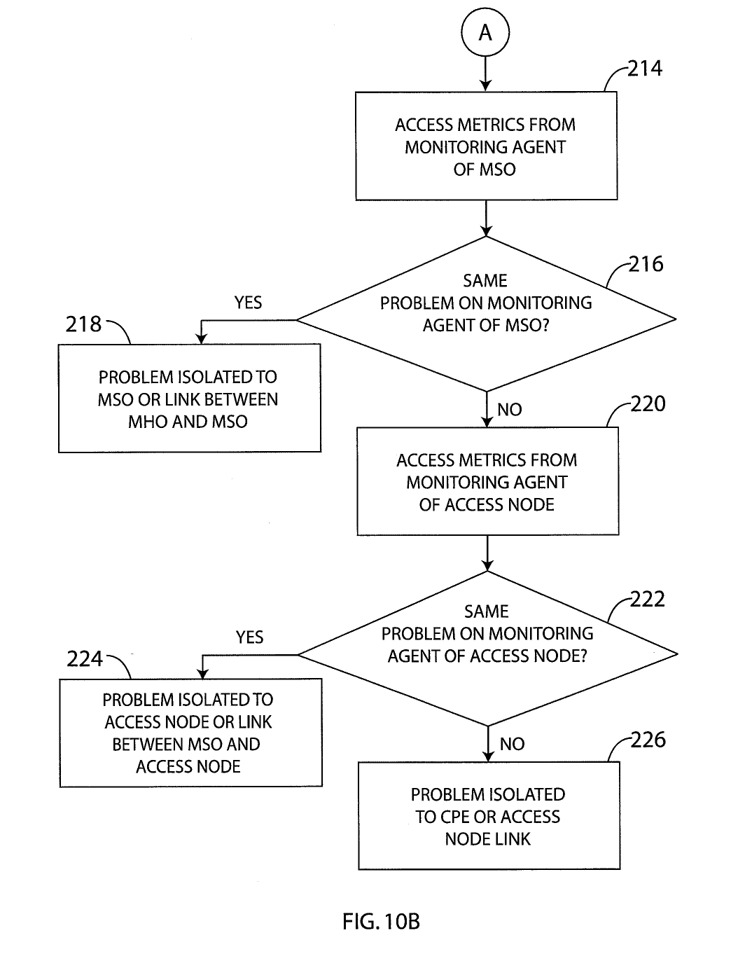

With reference to FIGS. 10A and 10B, a flow diagram is provided to illustrate a top down approach to isolating a fault location. In this example, assume that monitoring agents 40 are provided in the access node 24, the MSO 22, the MHO 20, and the MHE 18, as well as certain CPEs 26. Notably, any of these monitoring agents 40 may provide each of the steps in the process. In this scenario, assume the respective monitoring agents 40 in the access node 24, the MSO 22, the MHO 20, and the MHE 18 provide monitoring at the egress of the respective devices or locations.

Initially, the monitoring agent 40 will directly or indirectly detect an impairment trigger associated with the fault that occurred while a customer was receiving streaming media for channel X (step 200). The monitoring agent 40 may access metrics from the monitoring agent 40 of the MHE 18 (step 202) and determine if the same problem is occurring on the monitoring agent 40 of the MHE 18 (step 204). If the same problem is occurring on the monitoring agent 40 of the MHE 18, the problem may be determined to be isolated to the MHE 18 (step 206). If the same problem is not detected at the monitoring agent 40 of the MHE 18, metrics may be accessed from the monitoring agent 40 of the corresponding MHO 20, which may reside in the media path (step 208). If the same problem is detected on the monitoring agent 40 of the MHO 20 (step 210), the problem may be isolated to the MHO 20 or the link between the MHE 18 and the MHO 20 (step 212). If the same problem is not detected on the monitoring agent 40 of the MHO 20, metrics may accessed from the monitoring agent 40 of the corresponding MSO 22 (step 214). If the same problem is detected on the monitoring agent 40 of the MSO 22 (step 216), the problem may be isolated to the MSO 22 or the link between the MHO 20 and the MSO 22 (step 218). If the same problem is not detected on the monitoring agent 40 of the MSO 22, metrics may be accessed from the monitoring agent 40 of the access node 24 (step 220). If the same problem is detected by the monitoring agent 40 of the access node 24 (step 222), the problem may be isolated to the access node 24 or the link between the MSO 22 and the access node 24 (step 224). If the same problem is not detected on the monitoring agent 40 of the access node 24 (step 222), the problem may be isolated to the CPE 26 of the customer or the access node link between the access node 24 and the CPE 26 (step 226).

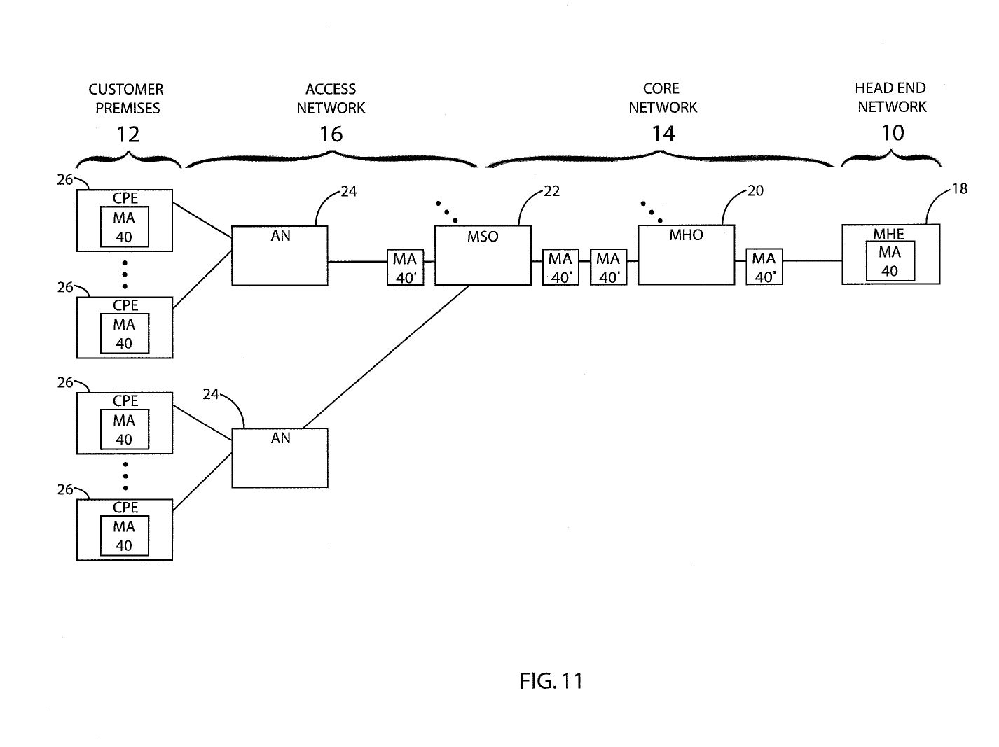

With reference to FIG. 11, multiple monitoring agents 40′ are associated with each of the MSO 22 and the MHO 20. In particular, assuming media streams flow from the MHE 18 toward the CPEs 26 through the MHO 20, the MSO 22, and the access node 24, respectively, the following is true. The MHO 20 is associated with an ingress and an egress monitoring agent 40′. Similarly, the MSO 22 is associated with an ingress and an egress monitoring agent 40′. The ingress monitoring agents 40′ are generally upstream of the associated location while the egress monitoring agents 40′ are generally downstream of the associated location. Notably, the CPEs 26 and the access nodes 24 may include monitoring agents 40. In this example, the process to isolate fault locations is a hybrid of the prior examples. Initially, a top down approach is taken until the fault has been isolated to a section downstream of a particular MSO 22. Once this section has been isolated, a bottom up approach is provided. Again, any monitoring agent 40 may provide the functionality of the process.

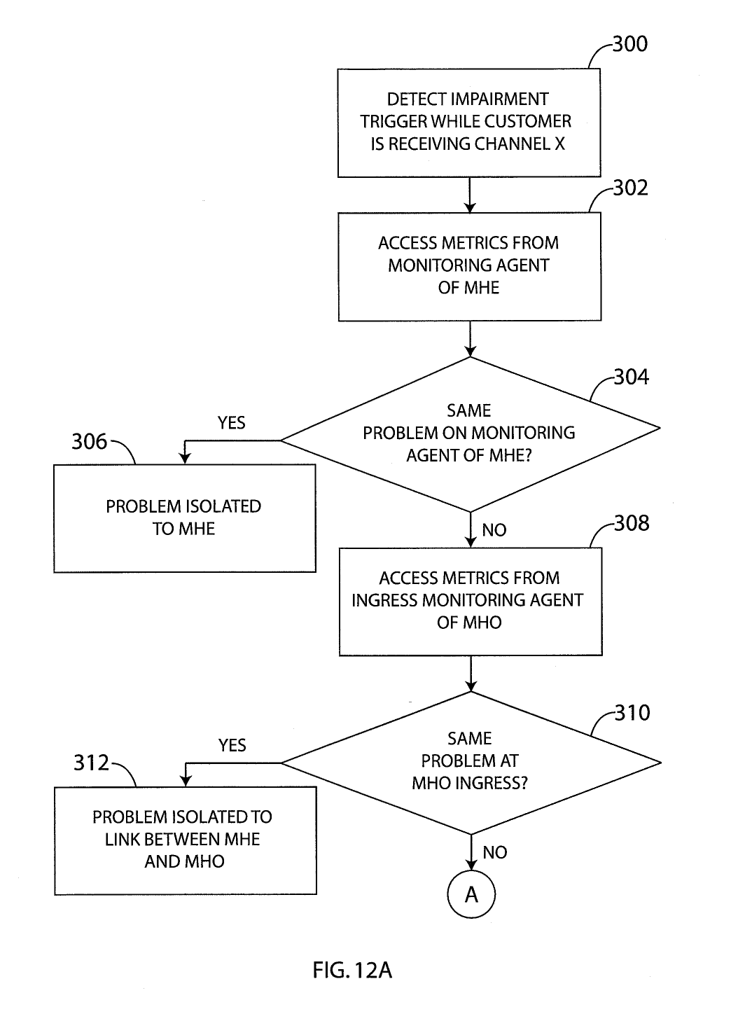

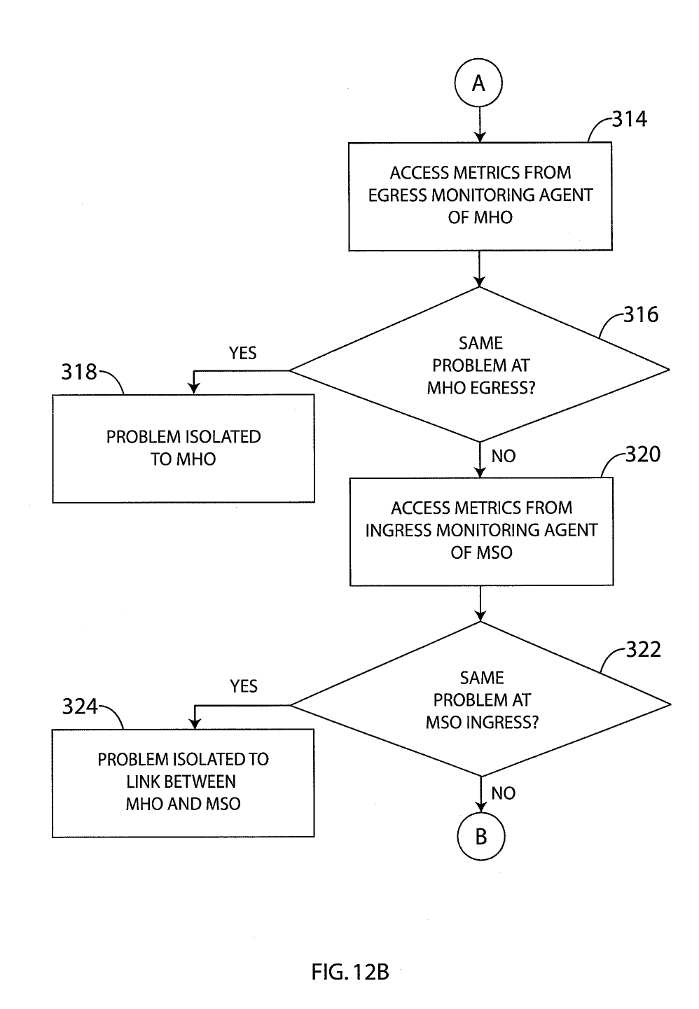

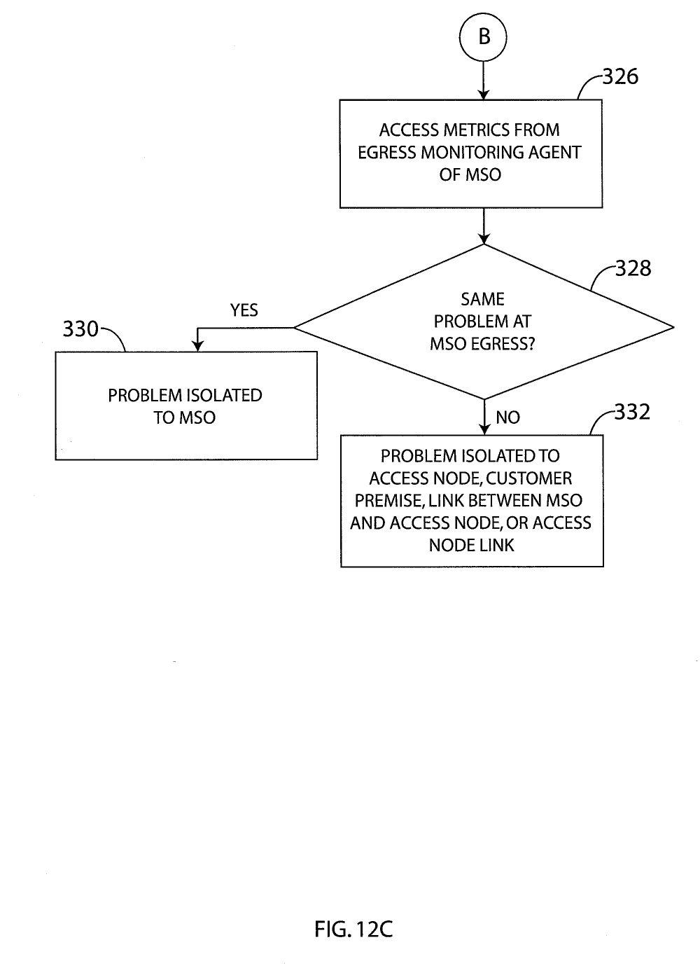

A flow diagram is provided in FIGS. 12A, 12B, and 12C to illustrate a hybrid approach to isolating a fault location for the network configuration provided in FIG. 11. The process starts by a monitoring agent 40 detecting an impairment trigger while a customer is receiving streaming media for channel X (step 300). Initially, metrics may be accessed from the monitoring agent 40 of the MHE 18 (step 302). If the same problem is detected on the monitoring agent 40 of the MHE 18 (step 304), the problem may be isolated to the MHE 18 (step 306). If the same problem is not detected on the monitoring agent 40 of the MHE 18, metrics may be accessed from the ingress monitoring agent 40′ of the MHO 20 (step 308). If the same problem is detected at the MHO 20 ingress (step 310), the problem may be isolated to the link between the MHE 18 and the MHO 20 (step 312). If the same problem is not detected at the MHO 20 ingress, metrics may be accessed from the egress monitoring agent 40′ of the MHO 20 (step 314). If the same problem is detected at the MHO 20 egress (step 316), the problem may be isolated to the MHO 20 (step 318). If the same problem is not detected at the MHO 20 egress, metrics may be accessed from the ingress monitoring agent 40′ of the MSO 22 (step 320). If the same problem is detected at the MSO 22 ingress (step 322), the problem may be isolated to the link between the MHO 20 and the MSO 22 (step 324). If the same problem is not detected at the MSO 22 ingress, metrics may be accessed from the egress monitoring agent 40′ of the MSO 22 (step 326). If the same problem is detected at the MSO 22 egress (step 328), the problem may be isolated to the MSO 22 (step 330). If the same problem is not detected at the MSO 22 egress, the problem may be isolated to the access node 24, the customer premises 12, the link between the MSO 22 and the access node 24, or the access node link to the CPE 26 in the customer premises 12 (step 332). At this point, the bottom up process may be started, as described in association with steps 100 through 112 of FIGS. 6A and 6B, to further isolate the problem in the customer premises 12 or the access node 24.

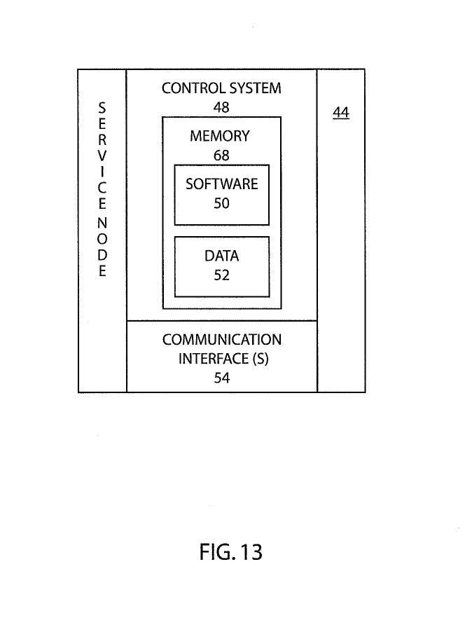

With reference to FIG. 13, a block representation of a service node 44 is provided. The service node 44 is generic control entity that may provide the functionality of the access node 24, as well as a service node in the MSO 22, in the MHO 20, in the MHE 18, or the management system 42. In particular, the service node 44 may include a control system 46 with sufficient memory 48 for the requisite software 50 and data 52 to facilitate operation as described above. In addition to providing the functionality of the overall device, the software 50 may provide the monitoring agent 40 or 40′, depending on the configuration. Further, the control system 46 may be associated with one or more communication interfaces 54 to facilitate communications as necessary for operation. The service node 44 may be a stand alone entity or may be part of another element such as an access node 24, switch, router, or the like.

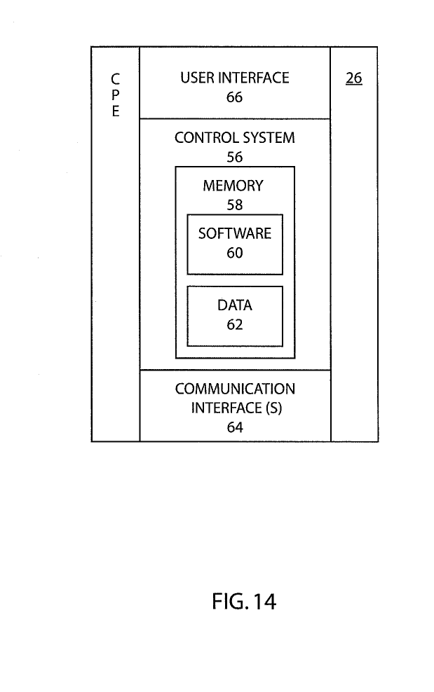

With reference to FIG. 14, a block representation of a CPE 26 is illustrated. The CPE 26 may include a control system 56 with sufficient memory 58 for the requisite software 60 and data 62 to operate as described above. Again, the software 60 may provide the functionality of the CPE 26 in general, as well as the monitoring agent 40. The control system 56 may be associated with one or more communication interfaces 64 to facilitate communications as described above. Further, the control system 56 may be associated with a user interface 66 to facilitate interactions with a customer as well as provide streaming media in an audible or viewable format to the customer as well as receive information from the customer.

Those skilled in the art will recognize improvements and modifications to the preferred embodiments of the present invention. All such improvements and modifications are considered within the scope of the concepts disclosed herein and the claims that follow.

What is claimed is:

1. A method of operating a first monitoring agent comprising:
receiving an impairment trigger relating to a fault associated with at least one media stream being delivered toward a customer;
initiating capture of a media segment of a media stream in response to detecting the impairment trigger; and
storing the media segment for subsequent analysis.

2. The method of claim 1 wherein the first monitoring agent is provided by a first device and the impairment trigger is received from a second device, which is located apart from the first device.

3. The method of claim 2 wherein the impairment trigger is received from a second monitoring agent of the second device and the impairment trigger was initiated in response to detecting the fault at the second device.

4. The method of claim 3 wherein the first device is customer premise equipment located on customer premises.

5. The method of claim 3 wherein the second device is customer premise equipment located on customer premises of the customer.

6. The method of claim 3 wherein the first device is customer premise equipment located on a first customer premises and the second device is customer premise equipment located on a second customer premises.

7. The method of claim 1 wherein the first monitoring agent is provided by a first device and the impairment trigger is provided by the first device in response to detecting the fault or receiving user input indicative of the fault.

8. The method of claim 1 further comprising buffering the media stream as the media stream is being received to enable capture of a portion of the media stream that was received prior to receiving the impairment trigger and wherein the media segment is captured to comprise the portion of the media stream that was received prior to receiving the impairment trigger.

9. The method of claim 8 wherein the media segment is a continuous portion of the media stream and further comprises a portion of the media stream that was received after receiving the impairment trigger.

10. The method of claim 8 wherein the media segment is stored in a protected designated area of a customer premises equipment storage medium.

11. The method of claim 10 further comprising managing a plurality of captured media segments, including the media segment in the protected designated area.

12. The method of claim 1 further comprising identifying metadata associated with the media segment and storing the metadata in conjunction with the media segment.

13. The method of claim 12 wherein the metadata and the media segment are synchronized in time.

14. The method of claim 13 further comprising delivering the media segment and the metadata to a remote device for the subsequent analysis.

15. A method of operating a first monitoring agent that resides in first customer premise equipment at a first customer premises comprising:
receiving a force tuning instruction from a second monitoring agent outside of the first customer premises;
initiating capture of a media segment of a first media stream in response to detecting the force tuning instruction; and
storing the media segment for subsequent analysis.

16. The method of claim 15 further comprising selecting the first media stream in response to receiving the force tuning instruction and begin receiving the first media stream.

17. The method of claim 16 wherein selecting the first media stream comprises changing from a second media stream to the first media stream.

18. The method of claim 17 further comprising negotiating with the second monitoring agent to determine at least one of when to begin receiving the first media stream, what metrics to record, and what information to report.

19. The method of claim 17 wherein the second monitoring agent resides in second customer premise equipment at a second customer premises.

20. The method of claim 15 wherein the second monitoring agent resides outside of any customer premises.

21. The method of claim 15 wherein the first customer premise equipment is receiving and presenting a primary media stream to a first customer and the media segment is captured without interfering with presentation of the primary media stream to the first customer.

22. A method for operating a first monitoring agent in a streaming media delivery network comprising:
receiving a plurality of fault alarms for a given problem from a plurality of monitoring agents in the streaming media delivery network, the plurality of fault alarms associated with at least one media stream being delivered toward customer premise equipment through the streaming media delivery network;
processing the plurality of fault alarms to provide fault information representative of the plurality of fault alarms for the given problem; and
delivering the fault information to an upstream monitoring agent.

23. The method of claim 22 wherein the first monitoring agent and the plurality of monitoring agents are each provided in different customer premise equipment on different customer premises.

24. The method of claim 22 wherein the plurality of monitoring agents are each provided in different customer premise equipment on different customer premises and the first monitoring agent is upstream of the plurality of monitoring agents.

25. The method of claim 22 wherein the plurality of monitoring agents comprise one of a group consisting of an access node, which serves the customer premise equipment; media switching offices, which serve the access nodes; and media hub offices, which serve the media switching offices.

26. The method of claim 22 wherein the plurality of monitoring agents are downstream from the first monitoring agent.

27. The method of claim 22 further comprising sending a message to at least one of the plurality of monitoring agents, the message configured to cause the at least one of the plurality of monitoring agents to suppress delivery of a subsequent fault alarm to the first monitoring agent.

28. The method of claim 27 wherein the subsequent fault alarm corresponds to the given problem.

29. The method of claim 22 wherein the plurality of monitoring agents are downstream of the first monitoring agent.

30. The method of claim 22 wherein the first monitoring agent and the plurality of monitoring agents are associated with a peer group, each member of the peer group having a peer list identifying other members of the peer group.

31. The method of claim 30 wherein the first monitoring agent is a master peer for the other members of the peer group.

32. The method of claim 31 wherein the master peer is elected by the peer group.

33. The method of claim 30 further comprising communicating with the plurality of monitoring agents and identifying them as members of the peer group.

34. A method of operating a first monitoring agent to locate a fault in a streaming media delivery network wherein streaming media is delivered through a plurality of service nodes prior to reaching customer premise equipment, each of the plurality of service nodes being located at different hierarchical levels and associated with a monitoring agent, the method comprising:
determining a fault has occurred in association with delivering the streaming media to the customer premise equipment;
systematically communicating with the monitoring agents for the service nodes at the different hierarchical levels to determine whether the monitoring agents for the service nodes have detected the fault at different hierarchical levels; and
determining a possible location of the fault based on which ones of the monitoring agents for the service nodes have or have not detected the fault.

35. The method of claim 34 wherein the systematic communications progress downward through the different hierarchical levels toward the customer premise equipment.

36. The method of claim 34 wherein the systematic communications progress upward through the different hierarchical levels away from the customer premise equipment.

37. The method of claim 34 wherein the first monitoring agent is located in the customer premise equipment.

38. A method of operating a first monitoring agent to automatically locate a fault in a switched digital media network wherein streaming media may be delivered through a plurality of service nodes prior to reaching a plurality of customer premise equipment wherein different ones of the plurality of service nodes reside along different paths to different customer premise equipment, the method comprising:
determining a fault has occurred in association with delivering the streaming media to certain customer premise equipment of the plurality of customer premise equipment;
systematically communicating with a monitoring agent associated with the plurality of customer premise equipment along the different paths to determine whether the monitoring agents associated with the plurality of customer premise equipment have detected the fault; and
determining a possible location of the fault based on which ones of the monitoring agents for the plurality of customer premise equipment have or have not detected the fault.

39. The method of claim 38 wherein the possible location of the fault may be determined to be at the certain customer premise equipment, which resides in a customer premises, or within the switched digital media network outside of the customer premises.
